(19) United States
(12) Patent Application Publication
(10) Pub. No.: US 2010/0306859 A1
(43) Pub. Date: Dec. 2, 2010

(54) SECURE MEDIA COPYING AND/OR PLAYBACK IN A USAGE PROTECTED FRAME-BASED WORK

(76) Inventor: Hank Risan, Santa Cruz, CA (US)

Correspondence Address: MEDIA RIGHTS TECHNOLOGIES C/O WAGNER BLECHER LLP, 123 WESTRIDGE DRIVE, WATSONVILLE, CA, 95076, US

(21) Appl. No.: 12/474,790

(22) Filed: May 29, 2009

(51) Int. Cl. G06F 21/00; G06F 17/00

(52) U.S. Cl. 726/32; 726/33; 700/94

(57) ABSTRACT

A system and method of secure copy and/or playback control of a usage protected frame-based work is disclosed. The method includes accessing serial copy management system information for the usage protected frame-based work. In addition, the method validates the serial copy management system information. Copy management information of the usage protected frame-based work is also accessed. In so doing, the copy management information is utilized to determine if a secure copy/playback application is authorized to generate a copy of the usage protected frame-based work. Thus the copy management information acts as a technological measure which “effectively controls access to a work” by requiring the application of information, with the authority of the copyright owner, to gain access to the work.

### FIELD

Embodiments of the present technology relates generally to the field of media usage copying and/or playback protection.

### BACKGROUND

Previously, if a user wanted a particular song or movie, the user would have to go to a store and purchase a record, tape, CD, video or the like. However, digitized audio and video media has revolutionized the media distribution market. Presently, if a user wants to buy a particular song or video, the media can be purchased and downloaded from the Internet. For example, an end user can access any of a number of media distribution sites, purchase and download the desired media and then listen or watch the media repeatedly.

In many cases, the media being purchased and downloaded will include some type of usage protection. Usage protection may be copy, transfer or playback limitations such as, but not limited to, copyright protection. In general, the usage protection allows the owner of the usage restricted media to control distribution of the media. For example, if the downloaded media is copyright protected, copyright royalties may be required by anyone copying, transmitting or subsequently downloading the protected media. In another example, the usage protection of the downloaded media may be controlled distribution. That is, there may be a “no copy” policy or a “few copies” policy. Presently, rules related to usage protection can be found under Title 17 of the United States Code.

Thus, a copyright owner of a usage protected media has a financial interest in receiving the proper copyright royalties for the use of the usage protected media. This interest includes protecting the usage protected media from being illegally copied and distributed. Under Title 17, the copyright owner has legal standing to require media distributors to protect the usage restricted material with technological measures.

### SUMMARY

A system and method of secure copy control of a usage protected frame-based work is disclosed. The method includes accessing serial copy management system information for the usage protected frame-based work. In addition, the method validates the serial copy management system information. Copy management information of the usage protected frame-based work is also accessed. In so doing, the copy management information is utilized to determine if a secure copy/playback application is authorized to generate a copy of the usage protected frame-based work. Thus the copy management information acts as a technological measure which “effectively controls access to a work” by requiring the application of information, with the authority of the copyright owner, to gain access to the work.

### BRIEF DESCRIPTION OF THE DRAWINGS

FIG. 1 is a block diagram of a system for enhancing copyright revenue generation, in accordance with an embodiment of the present invention.

FIG. 2 is a block diagram of a flow chart of a method for enhancing copyright generation, in accordance with an embodiment of the present invention.

FIG. 3 is a block diagram of a flow chart of a method for enhancing copyright generation, in accordance with an embodiment of the present invention.

FIG. 4 is a block diagram of a flow chart of a method for enhancing copyright generation, in accordance with an embodiment of the present invention.

FIG. 5 is a block diagram of a flow chart of a method for determining if secure media copying in a usage protected frame-based work is allowed, in accordance with an embodiment of the present invention.

FIG. 6 is a block diagram of a flow chart of a method for secure media copying in a usage protected frame-based work, in accordance with an embodiment of the present invention.

FIG. 7 is a block diagram of an exemplary computer system in accordance with one embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Overview

Under 17 U.S.C. 106 and 114, an owner of copyright in a sound recording has exclusive rights to the sound recording. For example, the copyright owner is limited to the right to duplicate the sound recording in certain forms that directly or indirectly recapture the actual sounds fixed in the recording. Also, the copyright owner is limited to the right to prepare a derivative work in which the actual sounds fixed in the sound recording are rearranged, remixed, or otherwise altered in sequence or quality.

However, there are certain limitations to the rights in the sound recordings. In particular, the exclusive rights of the owner of copyright in a sound recording do not extend to the making or duplication of another sound recording that consists entirely of an independent fixation of other sounds, even though such sounds imitate or simulate those in the copyrighted sound recording. In other words, copyright law allows one to create an imitation or simulation of a copyrighted sound recording as long as the imitated or simulated sounds are independently created.

Copyright law also requires a plurality of copyright royalties paid to the copyright owner for the use of copyrighted work, such as but not limited to performance royalties and publishing royalties. The royalty rates are set by the Copyright Royalty Board. In order for a copyright owner to enforce and collect copyright royalties, the copyright owner must have a valid copyright that is registered with the United States Copyright Office. A way to protect a copyright protected work and ensure payment of copyright royalties is through the use of technological measures that effectively control access to the copyright protected work, as described in 17 U.S.C. 1201.

A copyright owner of a copyright protected work must have legal standing to pursue a claim of copyright infringement. Distribution is a key element of standing for copyright infringement under Title 17. For example, when a copyright protected work having technological measures (e.g., SCMS) for the protection of the copyright protected work is distributed, any device or appliance that subsequently accepts and renders the copyright protected work is required to have technological measures in place (e.g., SCMS) so as to effectively control access to the copyrighted work and maintain the integrity of the copy controls, and copy management information on the work itself as required in section 1201, 1202 and 1001 of the Title 17. Thus, the copy management information acts as a technological measure which “effectively controls access to a work” by requiring the application of information, with the authority of the copyright owner, to gain access to the work.

### Operation

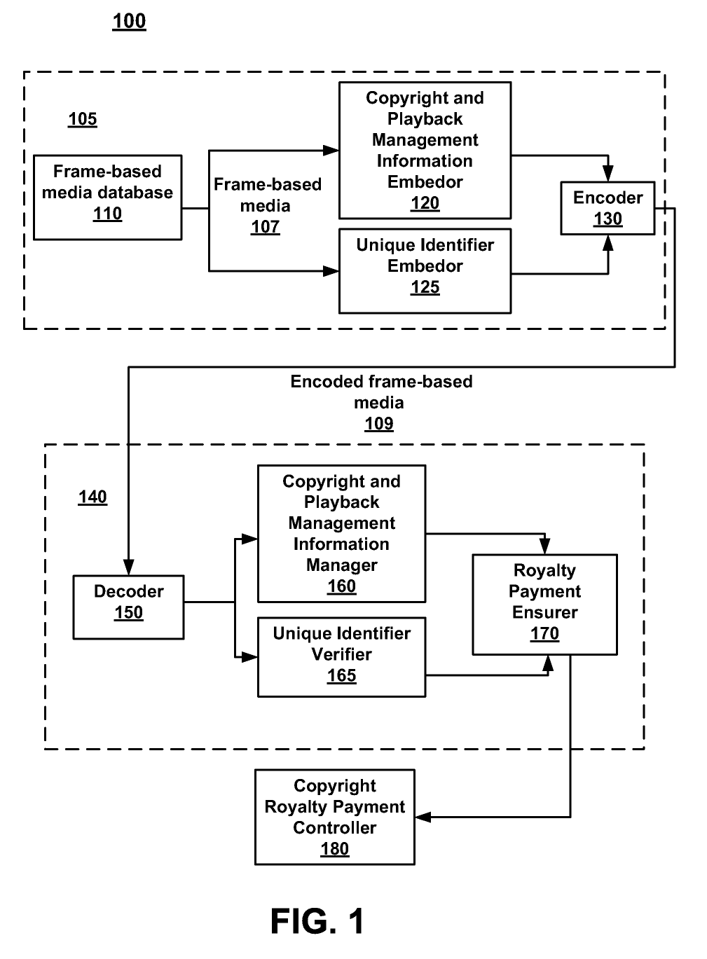

A media provider, such as a media web broadcaster, that provides a large database of media, such as but not limited to sound recordings, may transmit large volumes of copyrighted media and may be required to pay large amounts of royalty fees. An embodiment in accordance with the present invention provides a system 100 for enhancing copyright revenue generation, as illustrated in FIG. 1. System 100 includes a system 105, a device 140 and a copyright royalty payment controller 180. The system 105 includes a frame-based media database 110, a copyright and playback management information embedor 120, a unique identifier embedor 125 and an encoder 130.

The system 105 facilitates in the enhancing of copyright revenue generation by facilitating in the ensuring of appropriate payment of entitled copyright royalties. In one embodiment, the system 105 is a web broadcaster that broadcasts multimedia via the Internet. It should be appreciated that the multimedia is any frame-based media 107 which is stored in a frame-based media database 110. In one embodiment, the frame-based media 107 are MPEG-1 Audio Layer 3 (MP3) files.

In one embodiment, the system 105 facilitates the ensuring of appropriate payment of entitled copyright royalties of copyright works by introducing technological measures to the a copyright protected frame-based media 107 by way of copyright and playback management information embedor 120. In another embodiment, the system 105 facilitates the ensuring of appropriate payment of entitled copyright royalties of copyright works by introducing technological measures to the copyright protected frame-based media 107 by way of unique identifier embedor 125. It should be appreciated that a technological measure effectively controls access to a copyright protected work if the measure, in the ordinary course of operation, requires the application of information, or a process or treatment, with the authority of the copyright owner, to gain access to the copyright protected work. One purpose of technological measures it to help prevent counterfeit works.

It should be appreciated that the copyright and playback management information can be but is not limited to a SCMS. SCMS is a scheme to protect copyrights of digital productions by preventing data from being repeatedly copied. SCMS is built into an audio appliance which has a function to create a copy of digital data, such as an MP3 file. The audio appliance with the SCMS built into it can prevent a first-generation copy recorded by the user from being copied again. In other words, the SCMS prevents a second or higher generation copy from being created.

Copyright and playback management information embedor 120 embeds copyright and playback management information within frame-based media 107. It should be appreciated that the copyright and playback management information is any information related to the management and/or the enforcement of copyright protection associated with a copyright protected work. In various embodiments, the copyright and playback management information can be but is not limited to the number of copies allowed of the frame-based media, the number of copies allowed of the frame-based media, version number of the frame-based media or no copies allowed, rules for subsequent copies and the like, as well as the number of plays allowed of the frame-based media and the types of devices that are allowed to play the media.

In various embodiments, the copyright management information indicates which machine, product and/or company the copyright protected work came from. Additionally, the copyright management information indicates which machine, product and/or company the copyright protected work is allowed to be played back on.

It should also be appreciated that the copyright management information is forensics related information, such as but not limited to tracking information. For example, a demo of a copyright protected work is released to person “A.” The copyright protected work has an embedded unique number that is associated with person “A.” If the content of the demo is found elsewhere (e.g., not with person “A”), the content of the demo can be tracked back to its source.

Further, the copyright management information is an expiration date(s) associated with the copyright protected work. For example, the expiration date(s) associated with the copyright protected work is embedded in the copyright protected work and subsequently limits when the copyright protected work is able to be played back.

It should be appreciated that the copyright and playback management information embedor 120 embeds copyright and playback management information within at least one data field of the frame-based media 107. In one embodiment, the data field is an application-private bit of a MP3 file. Typically, MP3 files are segmented into thousands of frames. For example, a three to five minute song can have approximately 8,000 to 12,000 frames. Each frame contains a fraction of a second's worth of audio data. At the beginning of every data frame is a header frame which stores 32 bits of meta-data related to the coming data frame. The MP3 header begins with a sync block that consists of 11 bits. The sync block allows players to search for and lock onto the first available occurrence of a valid frame. Following the sync block are a plurality of other header blocks that facilitate in the proper decoding and subsequent playing of the MP3 file. One of the other header blocks is the application-private bit, which allows for application-specific triggers. For example, if there are 8,000 frames in an MP3 file, there is a private bit corresponding to each frame for a total of 8,000 private bits.

In one embodiment, the copyright and playback management information is a multiple bit data structure using the application-private bits in the MP3 frame headers across consecutive audio frames. For example, if the copyright and playback management information contains 32 bits, then each bit is stored in 32 consecutive application-private bits in corresponding 32 consecutive frames. In particular, the first bit of the copyright and playback management information is stored in the application-private bit of the header for the first audio frame. The second bit of the copyright and playback management information is stored in the application-private bit of the second audio frame and so on until all the data in the copyright and playback management information is stored in consecutive frames.

Further, the sequence of bits associated with the copyright and playback management information data block is continuously repeated throughout the entire audio file. Once the entire data block has been encoded, the first bit of the copyright and playback management information data block is stored in the application-private bit of the header for the next frame within the MP3 file. Accordingly, the playback application is able to detect the copyright and playback management information for the audio file irrespective of the starting position within the file from which the playback was initiated. For example, if the MP3 file has 8,000 frames and a corresponding 8,000 application private bits, then a copyright and playback management information data block of 32 bits is initially stored in the first 32 consecutive application-private bits and repeatedly stored in consecutive application-private bits, for a total of 250 consecutive and repeated instances of the copyright and playback management information data block stored in the entire MP3 file.

In one embodiment, the copyright and playback management information (CMI) is a 32-bit data structure having the following format. It should be appreciated that the 32-bit data structure is a SCMS data structure used to encode playback rights information in addition to copy control information. For example, a copyright holder may choose to allow a particular work to be played freely a certain number of times before requiring a license key or other access mechanism.

Elements of the 32-bit data structure are shown in Table 1:

| Offset | Description |
|---|---|
| 0 | First byte of CMI, set to fixed value to facilitate detection by a |
| | playback or secure copy/playback application |
| 8 | Second byte of CMI, set to fixed value to facilitate detection by |
| | a playback or secure copy application |
| 16 | Version number of CMI (three binary bits) |
| 19 | Flag indicating copying not allowed for audio file |
| 20 | If bit at offset 19 is not set, number of copies allowed for file |
| | (up to a maximum of 15). A value binary 0000 indicates that the |
| | file may be freely copied. |
| 24 | Number of plays allowed for file (up to a maximum of 255). |
| | If this field is set to binary 00000000, the file can be freely |
| | played. |

Additional security is available by using an encryption mechanism. Specifically, an encoder generates one or more sequences of data bytes to be used as keys for the encoding of the audio data for the file. The key sequences can be derived from a cryptographically secure digest taken across all or part of the data for the file. Thus, the key sequences are most likely different for each audio file.

The key sequences that are used for the encryption for all or part of the SCMS data block are unique to each copyright protected work. The key sequences can be generated using data from the copyright protected work. Thus the SCMS data block can be used to help ensure the integrity and authenticity of the copyright protected work.

It should be appreciated that to allow playback devices to more easily detect the presence of copyright and playback management information, the two marker bytes for each copyright and playback management information data block can be left unencoded.

It should be appreciated that stronger cryptographic algorithms impose the restriction that the data blocks to be processed should have sizes that are multiples of eight bytes or more. As such, the logic within the playback device to validate the copyright and playback management information could be complicated in nature.

In one embodiment, system 105 facilitates in the ensuring of appropriate payment of entitled copyright royalties of the copyright protected frame-based media 107 by adding technological measures to the frame-based media via unique identifier embedor 125. Unique identifier embedor 125 embeds at least one unique identifier into a frame-based media, such as but not limited to a MP3 file. It should be appreciated that the at least one unique identifier is invariant. In one embodiment, at least one unique identifier is embedded into metadata of an MP3 file, such as but not limited to an ID3V2 tag.

Further, at least one unique identifier is a valid copyright registration number from the United States Copyright Office associated with copyright protected frame-based media 107. Copyright registration establishes a public record of a copyright claim. A registration of a song with the United States Copyright Office could have a plurality of copyright registration numbers associated with the copyrighted song. For example, a song registered with the United States Copyright Office could have one copyright registration number for the lyrics of the song and the same song could have a different copyright registration number for the performance of the song. In another embodiment, at least two copyright registration numbers are embedded into ID3V2 tags of an MP3 file. It should be appreciated that the copyright registration numbers are any valid copyright registration numbers associated with the MP3 file, such as but not limited to copyright registration numbers associated with a simulation, an independent work of authorship, lyrics and the like. It should be appreciated that the embedding of at least one unique identifier is to help prevent tampering and counterfeiting of the frame-based media.

System 105 encodes the frame-based media subsequent to the copyright and playback management information embedor 120 embedding copyright and playback management information into the frame-based media 107 and/or the unique identifier embedor 125 embedding at least one unique identifier into the frame-based media 107. It should be appreciated that the encoding of the copyright and playback management information that is embedded into the frame-based media 107 does not alter the audio data in any way and does not compromise the integrity of the original work or simulation. Upon request by an end user, system 105 transmits encoded frame-based media 109 to media device 140.

Transcoding can be performed on a frame-based media that results in frameless media. For example, an MP3 file can be transcoded into another format (e.g., wav, AC3), such that it loses its frames, header, footer and as a result all that is left are the payloads. In a frameless media file, the copyright and playback information can be encoded by employing watermarking techniques. The copyright and playback information is encoded in the frameless media file by selecting a certain frequency not usually perceived by the listener and then changing its value to reflect the copyright and playback information data. It should be appreciated that mechanisms such as watermarking techniques operate directly upon the audio data and thus affect the rendering of the work.

For example, a video file when rendered often has the audio track data shunted off to the appropriate audio components. Similarly, in a frameless audio file, some component of the audio pathway could be modified to periodically look for the copyright and playback information. If a low frequency is selected and sampled, such that there is a guaranteed match on a significant pattern, the copyright and playback information can be further read for copyright and playback rules.

Media device 140 includes a decoder 150 that decodes the encoded frame-based media 109, copyright and playback management information manager 160, unique identifier verifier 165 and royalty payment ensurer 170. It should be appreciated that media device 140 is any media device capable of reading encoded frame-based media 109 and allowing a user of media device 140 to gain access to the transmitted frame-based media, such as but not limited to an MP3 player. It should also be appreciated that the media device 140 does not circumvent a technological measure. To circumvent a technological measure means to descramble a scrambled work, to descript an encrypted work, or otherwise to avoid, bypass, remove, deactivate, or impair a technological measure, without the authority of the copyright owner.

Copyright and playback management information manager 160 manages the frame-based media 107 according to the copyright and playback information that is embedded into the frame-based media. It should be appreciated that copyright and playback management information manager 160 manages the frame-based media 107 according to any information related to the management and/or the enforcement of copyright protection associated with frame-based media 107. For example, if the copyright and playback management information is a 32-bit data structure having the format, as shown above in Table 1, the copyright and playback management information manager 160 will manage the frame-based media 107 according to the rules set forth in Table 1. It should be appreciated that the copyright and playback management information manager 160 can be but is not limited to a SCMS, as described above, and manage the frame-based media 107 according the SCMS scheme embedded into frame-based media 107.

Unique identifier verifier 165 verifies that the at least one unique identifier embedded in the decoded frame-based media is the same unique at least one unique identifier that was embedded into the frame-based media 107. In one embodiment, unique identifier verifier 165 verifies that the two copyright registration numbers associated with the MP3 file embedded in the ID3V2 tags of an MP3 file are the same two copyright registration numbers associated with the MP3 file embedded in the ID3V2 tags subsequent decoding of the MP3 file in the device 140. It should be appreciated that if the unique identifier verifier 165 determines that the at least one unique identifier decoded at device 140 is the same as the at least one unique identifier that was embedded into the frame-based media 107, then it helps determine that the decoded frame-based media 107 has not been tampered with and is not a counterfeit. It should also be appreciated that the ID3V2 tags are metadata in the MP3 frame headers, as described above.

In one embodiment, the royalty payment ensurer 170 facilitates in ensuring appropriate payment of entitled copyright royalties of the copyright protected frame-based work 107 based at least in part on the embedded copyright and playback management information. Typically, the copyright owner of a copyright protected work is entitled to copyright royalties upon the transmission of a frame-based media 107. Based at least in part upon the output of the copyright management information manager 160 and the unique identifier verifier 166, the copyright owner of the frame-based media is ensured appropriate payment of entitled royalties. For example, if the copyright and playback management information manager 160 determines that the transmission of frame-based media 107 is only allowed to be copied three times, then the copyright and playback management manager 160 only allows for three copies of the frame-based media and the royalty payment ensurer 170 tracks the amount copies made which ensures appropriate payment of entitled royalties.

Further, the royalty payment ensurer 170 facilitates in ensuring appropriate payment of entitled copyright royalties of the copyright protected frame-based work 107 based at least in part on the embedded at least one unique identifier. For example, if the frame-based work 107 is a counterfeit frame-based work, the copyright owner of the copyright protected frame-based work would not receive the entitled royalties for the transmission, use and copying of the frame-based work. If the unique identifier verifier 165 verifying that the frame-based work 107 has not been tampered with or is not a counterfeit, the royalty payment ensurer 170, accordingly, tracks the use of the non-counterfeit frame-based work 107 and the copyright owner is then is ensured the proper entitled royalties for the use of the copyright protected work.

In general, if a copyrighted sound recording is transmitted to a user, the party transmitting the copyrighted sound recording is required to pay copyright royalties for the transmitted sound recording. The entitled copyright royalties can be but are not limited to a performance royalty and a publishing royalty. Generally, the performance is paid to the performers of the sound recording. The publishing royalty is paid to the songwriter of the lyrics of the song. Accordingly, if a party transmits an independent work of authorship, such as but not limited to a simulation, and the party owns the copyright of the independent work of authorship, the party is not required to pay a performance royalty that would otherwise have been paid to the prior owner of the copyright of the copyrighted media recording. However, the copyright owner of the independent work of authorship is required to pay a publishing royalty to the songwriter of the sound recording who wrote the lyrics to the sound recording and is entitled to a performance royalty for the imitated or simulated work performed. Therefore, there is an enhancing of copyright revenue generation because the party transmitting the independent work of authorship is entitled to copyright royalties (e.g. performance royalties) thereon that would have otherwise have been paid to the owner of the of the copyright of the copyrighted media recording. Additionally, not only will the independent work of authorship be subject to generating royalties, it is subject to registration for copyright protection.

For example, a user can purchase copyrighted media online at a digital media store. In some cases, the purchased media may be played on any media player application. However, in other cases, the purchased media may be played only on a media store specific media player application. In basic operation, the digital media store first obtains sufficient rights to offer each song for purchase and download. Upon purchase and download of the song to an end user, the digital media store is required to pay copyright royalties of the transmitted copyright song, such as but not limited to performance and publishing royalties.

For example, if the digital media store sells one copyrighted song to an end user for $1, the digital media store is required to pay an approximate $0.70 performance royalty as well as a $0.09 publishing royalty. If however an online digital store, created an independent work of authorship, such as but not limited to a simulation, and retained a copyright for the independent work of authorship, the digital media store would not be required to pay the performance royalty of a copyrighted song (e.g., $0.70) but instead could charge a performance royalty which would enhance the copyright revenue generation of the digital media store. Nevertheless, the digital media store does not create an independent work of authorship from a copyrighted media recording and is currently required to pay at least a performance and publishing royalty for each song transmitted to an end user.

The copyright royalty payment controller 180 receives information from the device 140 and pays the copyright owner of the copyright protected work for the use of the copyright protected work accordingly. It should be appreciated that the copyright royalty payment controller 180 can be but is not limited to a performing rights organization (e.g., The American Society of Composers, Authors and Publishers, Broadcast Music, Inc., SESAC, Inc. and SoundExchange) and/or mechanical rights agency (e.g., Harry Fox Agency and Canadian Mechanical Rights Reproduction Agency).

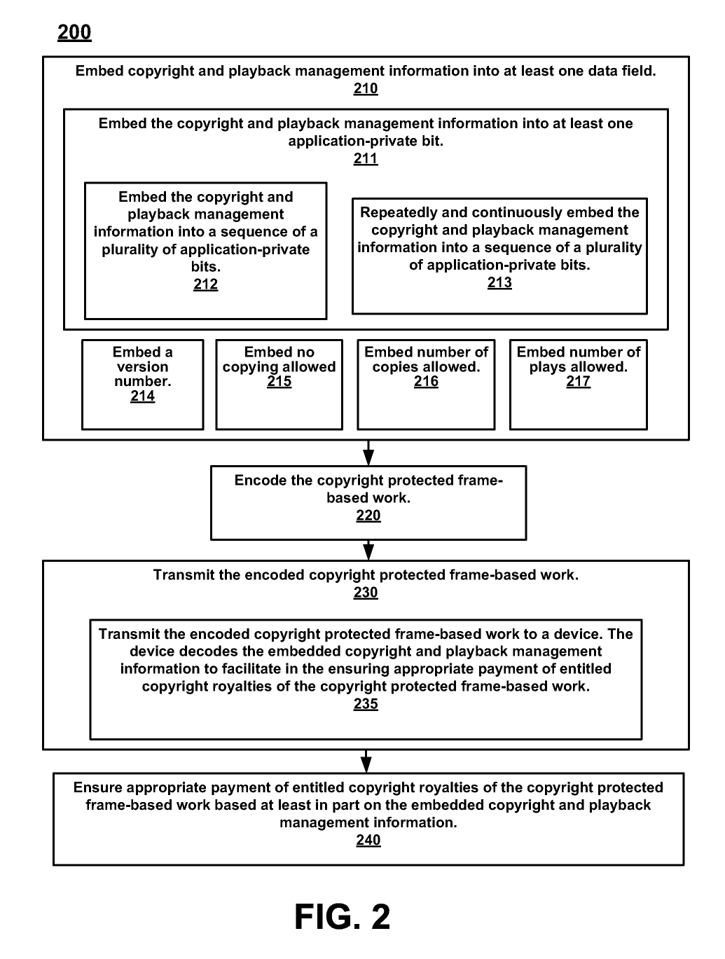

FIG. 2 is a flowchart illustrating a process 200 for enhancing copyright revenue generation. In one embodiment, process 200 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In one embodiment, process 200 is performed at least by system 105 of FIG. 1. It should be appreciated that system 105 could be a machine or computer that at least includes frame-based media database 110, copyright and playback management information embedor 120, unique identifier embedor 125 and encoder 130.

At block 210 of FIG. 2, copyright and playback management information is embedded into at least one data field of the copyright protected frame-based work. The copyright and playback management information corresponds to access to the copyright protected frame-based work. In one embodiment, at block 211, the copyright and playback management information is embedded into at least one application-private bit of at least one corresponding frame of a MP3 file. In another embodiment, at block 212, the copyright and playback management information is embedded into a sequence of a plurality of application-private bits. In another embodiment, at block 213, the copyright and playback management information is repeatedly and continuously embedded into a sequence of a plurality of application-private bits.

At block 214, the copyright and playback management information is a version number of the work. At block 215, the copyright and playback management information is no copying allowed of the work. At block 216, the copyright and playback management information is a number of copies allowed for the work. At block 217, the copyright and playback management information is a number of plays allowed for the work.

At block 220, the copyright protected frame-based work is encoded. At block 230, the encoded copyright protected frame-based work is transmitted. In one embodiment, at block 235, the encoded copyright protected frame-based work is transmitted to a device. The device decodes the embedded copyright and playback management information to facilitate in the ensuring appropriate payment of entitled copyright royalties of the copyright protected frame-based work. At block 240, appropriate payment of entitled copyright royalties of the copyright protected frame-based work is ensured based at least in part on the embedded copyright and playback management information.

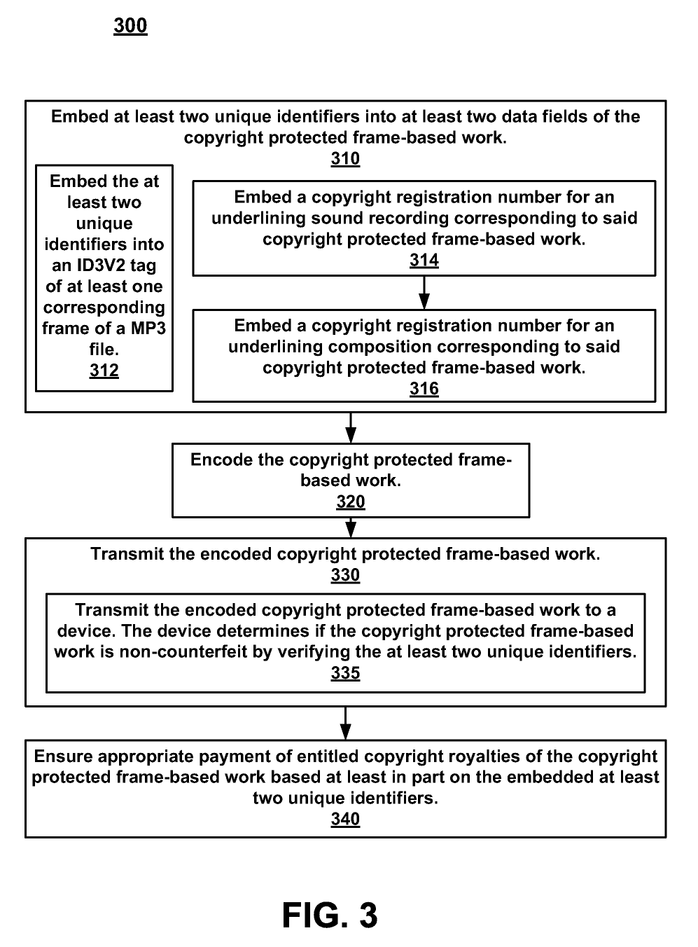

FIG. 3 is a flowchart illustrating a process 300 for enhancing copyright revenue generation. In one embodiment, process 300 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In one embodiment, process 300 is performed at least by system 105 of FIG. 1. It should be appreciated that system 105 could be a machine or computer that at least includes frame-based media database 110, copyright and playback management information embedor 120, unique identifier embedor 125 and encoder 130.

At block 310, at least two unique identifiers are embedded into at least two data fields of the copyright protected frame-based work. The embedding of the at least two unique identifiers corresponding to access to the copyright protected frame-based work. In one embodiment, at block 312, the at least two unique identifiers are embedded into an ID3V2 tag of at least one corresponding frame of a MP3 file. In another embodiment, at block 314, a copyright registration number for an underlining sound recording corresponding to the copyright protected frame-based work is embedded into the frame-based work. At block 316, a copyright registration number for an underlining composition corresponding to the copyright protected frame-based work is embedded into the frame-based work.

At block 320, the copyright protected frame-based work is encoded. At block 330, the encoded copyright protected frame-based work is transmitted. In one embodiment, at block 335, the encoded copyright protected frame-based work is transmitted to a device. The device determines if the copyright protected frame-based work is non-counterfeit by verifying the at least two unique identifiers. At block 340, appropriate payment of entitled copyright royalties of the copyright protected frame-based work is ensured based at least in part on the embedded at least two unique identifiers.

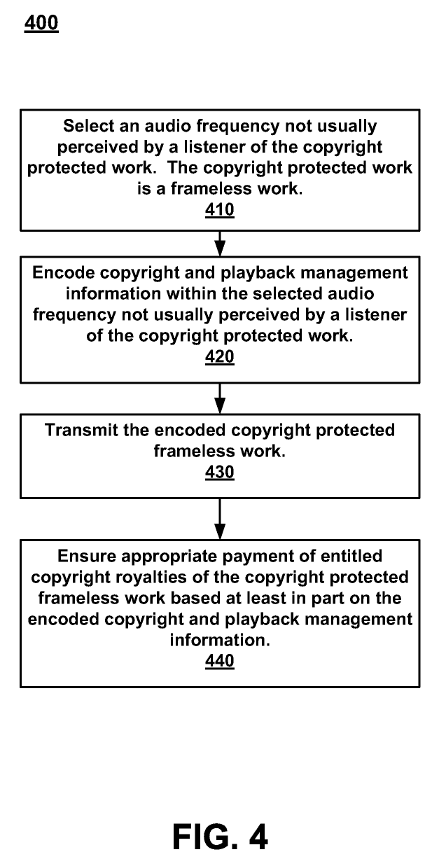

FIG. 4 is a flowchart illustrating a process 400 for enhancing copyright revenue generation. At block 410, an audio frequency is selected that is not usually perceived by a listener of the copyright protected work. The copyright protected work is a frame-based work that is transcoded to a frameless work. At block 420, copyright and playback management information is encoded within the selected audio frequency not usually perceived by a listener of the copyright protected work. At block 430, the encoded copyright protected frameless work is transmitted to an end user. At block 440, appropriate payment of entitled copyright royalties of the copyright protected frameless work is ensured based at least in part on the encoded copyright and playback management information.

### Copy Rules

In general, the present discussion provides a secure copy/playback application capable of allowing or denying the copying and/or playback of a media file. Embodiments of the media file may include audio, video, or the like. For example, a user purchases an MP3 song and the song is downloaded to a media player application library on the user's computer. The MP3 song has an associated usage protection which may be copy, transfer or playback limitations, such as, but not limited to, copyright protection. In this example, the MP3 song usage restriction allows the user to make no copies. As such, the secure copy/playback application would not allow the user to burn a copy of the MP3 song to a CD, download the song to an MP3 player, etc. In other words, a single copy of the song (the original downloaded version) would be stored on the user's computer only.

In another example, the user purchases a video and the video is downloaded to a media player application library on the user's computer. The video is copyright protected and the usage protection allows the user to make three (3) copies. As such, the secure copy/playback application would allow the user to make a maximum of three copies. For example, burning a copy of the video to a CD or DVD, downloading the video to a handheld video player, making a back-up copy, etc. In other words, a single copy of the video would remain on the user's computer while a possible three other copies may be made and utilized.

In one embodiment, the present technology utilizes the same frame-based work and methodology for authorized and controlled copying as well as authorized and controlled playback of media. Thus, unless otherwise noted, it is understood that throughout the text playback may be substituted for copy. In another embodiment, playback and copy control may be performed by separate devices and operation. However, for purpose of clarity, authorized and controlled copying and/or playback of media is utilized in the discussion and examples.

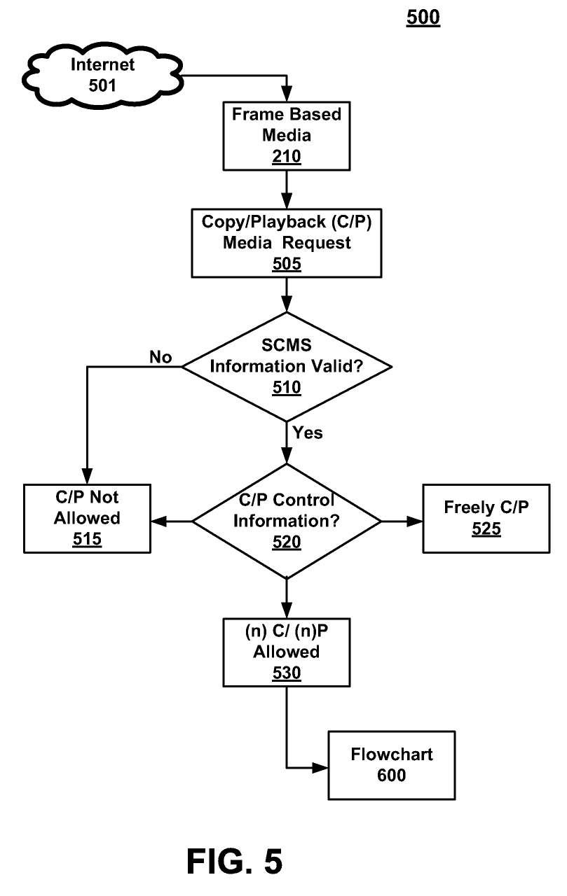

With reference now to FIG. 5, a flow chart 500 of a method for determining if secure media copying and/or playback (C/P) in a usage protected frame-based work is allowed is shown in accordance with an embodiment of the present invention. In one embodiment, the method described herein provides a number of rules that a secure copy/playback application may follow in order to be compliant with SCMS and CMI. While the following rules are provided as one exemplary embodiment for secure copy and/or playback limitation, it should be understood that in other embodiments, additional rules may be added or presently provided rules may be ignored. Moreover, in the present discussion, the term copy is utilized, however in alternate embodiments, copying may be replaced by terms such as duplication, sharing, and the like.

With reference now to 501 of FIG. 5, one embodiment utilized the Internet to deliver multimedia broadcasts. It should be appreciated that the multimedia may be any frame-based media 107 stored in a frame-based media database 110. In one embodiment, the frame-based media 107 are MPEG-1 Audio Layer 3 (MP3) files. The methods and systems described with respect to FIGS. 1-4 may then be performed on or utilized with respect to the multimedia.

Referring now to 505 of FIG. 5, a copy and/or Playback (C/P) media request is generated.

With reference now to 510 of FIG. 5, the frame based media 210 is checked for valid SCMS information. In one embodiment, the following terms are utilized to clarify and differentiate between the numerous possible configurations of frame-based media 210. For example, the original frame-based media 210 will either have valid SCMS data or it will have invalid or missing SCMS data. Original frame-based media 210 having invalid or missing SCMS data is also referred to herein as a destination file.

As shown at 515, a destination file of frame based media 210 is a C/P not allowed version. For example, the SCMS frame-based work will not permit a destination file to be copied if it can be definitively determined that the source file has no SCMS information. In one embodiment, although the copying and playback control utilize the same structure, it does not mean that a no-copy file is an unplayable file or that an unplayable file is a no-copy file. In other words, it is quite possible that a user will have a media file that does not contain SCMS information. As such, although a copy may not be allowed, it does not mean that the file cannot be freely played.

For example, in one embodiment, the media file may be from a source that did not include SCMS information. As such, the secure copy/playback application would ensure no-copies are made, thereby supporting owner copyrights. However, the secure copy/playback application may not necessarily stop the file from being played.

In another embodiment, if the media file does not contain SCMS information, the secure copy/playback application may not allow copying or playback of the media.

With reference again to 515 of FIG. 5, if the source file has detectable SCMS information, but the information is either corrupt or internally inconsistent, then the secure copy/playback application should not copy the file. Again, in one embodiment, the playback of the file may also be not allowed.

The following examples illustrate a few of the plurality of possible cases where tampering of the SCMS information in a frame-based MP3 file can be suspected.

If the MPEG audio tag or ID3v2 tag for the audio file has been modified, the encoded portion of the SCMS data block will decode to invalid information.

If the application-private bits for some of the MP3 frame headers have been modified, but not all of the frame headers, then one or more valid SCMS data blocks may be detected within the file.

In contrast, in one embodiment, the file may be considered to have valid SCMS information based on heuristics including, but not limited to:

An SCMS marker sequence is found at least once within the audio file.

The usage restricted, original, and protect bits are set in all of the audio frames for the file.

Fields within the SCMS data block that are marked as reserved are set to zero, and version information is set to a recognized value.

In another embodiment, the file will have valid SCMS information if all of the following conditions are met:

For every audio frame in the file, the frame header has the usage restricted, original, and protect bits set.

SCMS data blocks are found throughout the entire audio file, and these data blocks have valid formats. Specifically, each SCMS data block has the correct two-byte marker, the version field corresponds to a recognized version of the SCMS specification, and the reserved field is set to a value of zero.

In one embodiment, it is possible for an encoding application to set the application-private bits in the frames for an MP3 file to arbitrary values. It is also possible that an encoding application will use the application-private bit for its own purposes. In general, the utilization of the application-private bit will not necessarily invalidate the SCMS information.

With reference now to 520 of FIG. 5, in one embodiment, original frame-based media 210 having valid SCMS data will include C/P control information such as the information 210-217 of FIG. 2. For example, information addressing the number of copies (n) allowed to be made or playbacks allowed to be played. The number of copies (n) or playbacks will normally be defined by the copyright owner or distributor. In general, the number of copies (n) and or the number of playbacks will fall into one of three categories: n=unlimited, n=a certain number and n=0. In general, the number of playbacks does not need to correlate with the number of copies. Although, in one embodiment, as described in further detail herein, the number of playbacks may be established for each copy during the copying of the file.

At 525 of FIG. 5, a frame-based media 210 having valid SCMS data that has a value n=unlimited is referred to herein as an unlimited file. In one embodiment, an unlimited file may be freely C/P. Moreover, an unlimited file may be C/P by, or outside of, the secure copy/playback application defined in flowchart 600.

In contrast, at 515 of FIG. 5, a frame-based media 210 having valid SCMS data that has a value n=0 would be similar to C/P not allowed 215 of FIG. 2, also referred to herein as a destination file. In other words, if the copy control information specifies that copying is not permitted for the file, then the secure copy/playback application should not copy the file. Additionally, if the original bit in any of the MP3 frame headers for the source file is not set, then the secure copy/playback application should not copy the file, irrespective of the state of the original bits in the headers for the other frames in the file. Moreover, in one embodiment, if the source file is copy protected, or otherwise cannot be modified, then the secure copy/playback application should not copy the file.

However, although in one embodiment the copying and playback control utilize the same structure, it does not mean that a no-copy file is an unplayable file or that an unplayable file is a no-copy file. In other words, although the copy and/or playback utilize the same processes, in one embodiment, they are independent. Thus, it is quite possible that a user will have a no-copy media file that may be freely played.

With reference to 530 of FIG. 5, in one embodiment a frame-based media 210 having valid SCMS data that provides for a limited number (n) of copies and/or a limited number of playbacks allowed such as shown at 216 of FIG. 2, is referred to herein as a source file. For clarity, the following discussion is directed toward a source file that is allowed to be copied a total of (n) times. However, in another embodiment, if it is the playbacks that are limited to a certain number (n), the number of playbacks may be similarly controlled. In yet a further embodiment, both the number of copies and the number of playbacks may be simultaneously controlled for a given media file.

With respect now to flowchart 600, a method for secure media copying in a usage protected frame-based work is shown in accordance with an embodiment of the present invention. For example, once the copy control information at 520 and 530 of FIG. 5 specifies that the creation of one or more copies is allowed, secure copy/playback application 612 will make a destination file 625 of source file 610.

In one embodiment, secure copy/playback application 612 generates a target file 615 before initiating the copy process. In general, target file 615 is a working copy of source file 610. In one embodiment, the target file is an exact duplicate of the source file including the (n) value. The secure copy/playback application will then utilize target file 615 to generate the destination file 625 and the source file 630. In so doing, if any copying errors damage the file being copied, it is target file 615 that is damaged and not source file 610. In another embodiment, secure copy/playback application 612 may not utilize a target file 615 and may perform the copying process directly from source file 610.

In one embodiment, when target file 615 is copied by the secure copy/playback application 612, the result will include a destination file 625 and a source file 630 having (n−1) available copies remaining. In another embodiment, if secure copy/playback application 612 performs the copying process directly from source file 610, the result may include a destination file 625 and a source file 630 having (n−1) available copies remaining. However, in yet another embodiment, if secure copy/playback application 612 performs the copying process directly from source file 610, the result may include a destination file 625 and a change only to the copy allowance from (n) to (n−1) within source file 610.

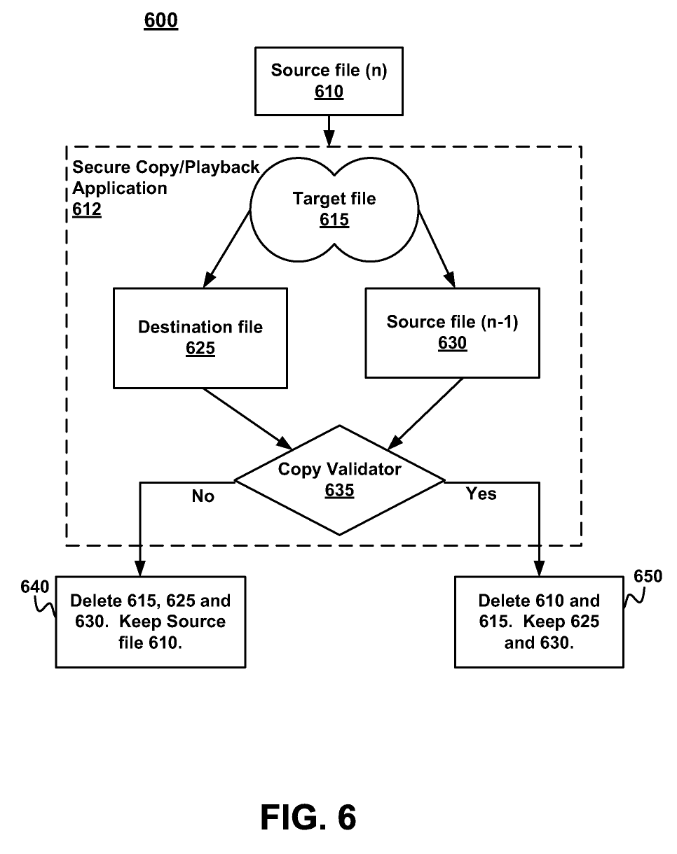

With reference still to FIG. 6, in one embodiment the destination file 625 has valid SCMS information specifying that copies are not permitted. In addition, in one embodiment, the original media bit in the MP3 frame headers for the destination file 625 should not be set, but the usage restricted and protect bits should be set.

In one embodiment, when source file 630 is created, the copy control information for source file 630 is modified to reflect that destination file 625 has also been made. For example, if the copy control information for source file 610 indicated that three copies were permitted (n=3) before the copy operation was performed, then source file 630 would show two allowed copies remaining (n=2). When the last allowed copy is made, the copy control information should be set to indicate that copying is not permitted for source file 630 (n=0). In other words, when the number of copies of the source file reaches (n=0) the two final copies will include a destination file 625 and a source file 630 with (n=0), the difference between the two being that the destination file will not have the original media bits set in the MP3 frame headers. At that time, the frame-based media 210 would no longer be able to be copied.

In one embodiment, validator 635 of FIG. 6 validates destination file 625 and source file 630. For example, as shown at 640, if an error occurs during the copy operation and the copies cannot be validated, the source file 610 is restored, and the target file 615, destination file 625 and source file 630, if created, are deleted. Thus, by utilizing the target file 615 even if the error condition that caused the copy operation to fail deleteriously affects target file 615, the integrity of source file 610 is maintained. In other words, by utilizing the target file 615 the secure copy/playback application is able to without compromising the copy control for the source file 610.

However, with reference now to 650 of FIG. 6, if destination file 625 and source file 630 are validated, then source file 610 and target file 615 are deleted and destination file 625 and source file 630 adjusted to now allowable copies (n−1) are kept. In one embodiment, both flowcharts 500 and 600 may be repeated until no further copying is allowed. In one embodiment, during the generation of the last available destination file, the result of the copying will include two destination files.

Although the example herein utilized 3 copies allowed per source file 610 or 10 playbacks per file, these numbers are provided merely for purposes of clarity within the examples provided. Thus, it is possible that the number of copies allowed or number of playbacks per file may be fixed at a different number and may also vary by content or media type. For example, in one embodiment a media copyright owner may choose another value for the number of copies allowed and/or number of playbacks per file.

Furthermore, in one embodiment, if there is a difference between the rule for the number of copies or plays allowed with respect to the SCMS and the number of copies or plays defined by the copyright owner, the number of copies allowed will default to the lesser of the number of copies. For example, the number of copies allowed may be set to default to the SCMS number of copies allowed as long as it is not larger than the copyright owner's suggested number of copies.

In another embodiment, if the copyright owner and the SCMS have a differing number of copies allowed rules (e.g., SCMS (4) copies; copyright owner (6) copies), a hierarchical rule may be utilized such that preference is provided to one over the other regardless. For example, the number of copies allowed would become the copyright owner's suggested number of copies (6).

### Example Computing System

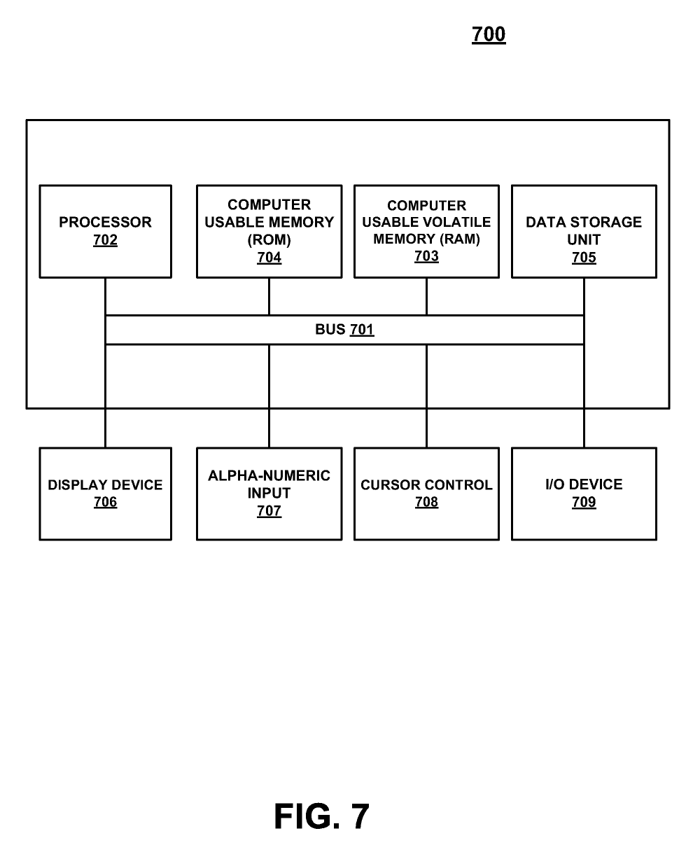

Referring now to FIG. 7, a diagram of computer system 700 in accordance with one embodiment of the present invention is shown in greater detail. Within the discussions certain processes are discussed that are realized, in one embodiment, as a series of instructions that reside within computer readable memory units of system 700 and executed by processor 702 of system 700. When executed, the instructions cause the computer system 700 to perform specific functions and exhibit specific behavior as described.

In general, computer system 700 used by the embodiments of the present invention comprises an address/data bus 701 for communicating information, one or more central processors 702 coupled with the bus 701 for processing information and instructions, a computer readable volatile memory unit 703 (e.g., random access memory, static RAM, dynamic, RAM, etc.) coupled with the bus 701 for storing information and instructions for the central processor(s) 702, a computer readable non-volatile memory unit 704 (e.g., read only memory, programmable ROM, flash memory, EPROM, EEPROM, etc.) coupled with the bus 701 for storing static information and instructions for the processor(s) 702.

System 700 also includes a mass storage computer readable data storage device 705 such as a magnetic or optical disk and disk drive coupled with the bus 701 for storing information and instructions. Optionally, system 700 can include a display device 706 coupled to the bus 701 for displaying information to the computer user (e.g., maintenance technician, etc.), an alphanumeric input device 707 including alphanumeric and function keys coupled to the bus 701 for communicating information and command selections to the central processor(s) 702, a cursor control device 708 coupled to the bus for communicating user input information and command selections to the central processor(s) 702, and a signal generating input/output device 709 coupled to the bus 701 for communicating command selections to the processor(s) 702.

Examples of well known computing systems, environments, and configurations that may be suitable for use with the present technology include, but are not limited to, personal computers, server computers, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

What is claimed is:

1. A method of secure copy control of a usage protected frame-based work, said method comprising:
accessing a serial copy management system information for said usage protected frame-based work;
validating said serial copy management system information;
accessing copy management information of said usage protected frame-based work; and
utilizing said copy management information to determine if a secure copy/playback application is authorized to generate a copy of said usage protected frame-based work.

2. The method of claim 1, further comprising:
accessing playback management information of said usage protected frame-based work.

3. The method of claim 2, further comprising:
accessing said serial copy management system information and said usage and playback management information from at least two application-private bits of an MP3 file.

4. The method of claim 1, further comprising:
allowing no copies of said usage protected frame-based work if said validating of said serial copy management system information fails.

5. The method of claim 1, wherein said copy management information comprises:
allowing no copies of said usage protected frame-based work.

6. The method of claim 1, wherein said copy management information comprises:
allowing a limited number of copies of said usage protected frame-based work.

7. The method of claim 2, wherein said playback management information comprises:
allowing a limited number of plays of said usage protected frame-based work.

8. The method of claim 1, wherein said copy management information comprises:
allowing an unlimited number of copies of said usage protected frame-based work.

9. The method of claim 2, wherein said playback management information comprises:
allowing an unlimited number of plays of said usage protected frame-based work.

10. A computer readable medium having computer implementable instructions stored thereon, said instructions for causing a compliance mechanism to perform a method of secure copy and playback control of a usage protected frame-based work, said method comprising:
accessing a serial copy management system information for said usage protected frame-based work;
validating said serial copy management system information;
accessing copy and playback management information of said usage protected frame-based work; and
utilizing said copy management information to determine if a secure copy and playback application is authorized to generate a copy of said usage protected frame-based work.

11. The computer readable medium of claim 10, further comprising:
accessing said serial copy management system information and said usage restricted and playback management information from at least two application-private bits in an MP3 file.

12. The computer readable medium of claim 10, further comprising:
allowing no copies of said usage protected frame-based work if said validating of said serial copy management system information fails.

13. The computer readable medium of claim 10, wherein said copy and playback management information comprises:
allowing no copies of said usage protected frame-based work.

14. The computer readable medium of claim 10, wherein said copy and playback management information comprises:
allowing a limited number of copies of said usage protected frame-based work.

15. The computer readable medium of claim 10, wherein said copy and playback management information comprises:
allowing a limited number of playbacks of said usage protected frame-based work.

16. The computer readable medium of claim 10, wherein said copy and playback management information comprises:
allowing an unlimited number of copies and playbacks of said usage protected frame-based work.

17. A system for secure and controlled copying and playback of a usage protected frame-based work comprising:
a computer storage medium having instruction stored therein, said instructions when executed causing a computer system to perform secure and controlled copying and playback of a usage protected frame-based work, said instructions comprising:
a source file receiver receiving a source file of said usage protected frame-based work, said source file having (n) copy and (n) playback management information associated therewith;
a destination file generator generating a destination file based on said source file of said usage protected frame-based work said destination file having (0) copy and (n) playback management information associated therewith;
a modified source file generator generating a modified source file based on said source file of said usage protected frame-based work said modified source file having (n−1) copy and (n) playback management information associated therewith; and
a validator validating said destination file and said modified source file based on said source file of said usage protected frame-based work.

18. The system of claim 17, further comprising:
a target file generator generating a target file based on said source file of said usage protected frame-based work said target file having (n) copy and (n) playback management information associated therewith, said destination file generator and said modified source file generator utilizing said target file in place of said source file of said usage protected frame-based work.

19. The system of claim 18, wherein if said validating fails said validator deletes said target file, said destination file and said modified source file of said usage protected frame-based work and keeps said source file of said usage protected frame-based work.

20. The system of claim 18, wherein if said validating succeeds said validator deletes said target file and said source file of said usage protected frame-based work and keeps said destination file and said modified source file of said usage protected frame-based work.
